(19) United States
(12) Patent Application Publication
(10) Pub. No.: US 2010/0142565 A1
(43) Pub. Date: Jun. 10, 2010

(54) LASER LIGHT SOURCE

(75) Inventors: Kazuo NAKAMAE, Yokohama-shi (JP); Motoki KAKUI, Yokohama-shi (JP); Shinobu TAMAOKI, Yokohama-shi (JP); Yasuomi KANEUCHI, Yokohama-shi (JP)

Correspondence Address: VENABLE LLP, P.O. BOX 34385, WASHINGTON, DC, 20043-9998, US

(73) Assignee: SUMITOMO ELECTRIC INDUSTRIES, LTD., Osaka-shi (JP)

(21) Appl. No.: 12/634,193

(22) Filed: Dec. 9, 2009

(30) Foreign Application Priority Data
Dec. 10, 2008 (JP) 2008-314665

(51) Int. Cl. H01S 3/113; H01S 3/11; H01S 3/125; H01S 3/121

(52) U.S. Cl. 372/11; 372/10; 372/16; 372/14

(57) ABSTRACT

The present invention relates to a laser light source having a structure that has high durability to support high power output. The laser light source is an optical device that pulse-oscillates laser light and has a resonator, a rare earth element doped fiber, pumping means, Q switch means, and a condensing lens. The resonator forms a resonance optical path. A fiber is inserted on the resonance optical path and outputs radiation light by supply of pumping energy. The pumping means continuously supplies pumping energy to the fiber. The Q switch means modulates resonator loss of the resonator. The condensing lens condenses the radiation light whose spot size has been expanded and which propagates from the fiber to the Q switch means. The Q switch means is disposed such that a portion contributing to at least a resonator loss modulation is located at the condensing point of radiation light which is condensed by the condensing lens, and mechanically changes formation and interruption of the resonance optical path by transmitting or interrupting the radiation light in the contributing portion.

### BACKGROUND OF THE INVENTION

1. Field of the Invention

The present invention relates to a laser light source which pulse-oscillates laser light.

2. Related Background of the Invention

A laser light source that pulse-oscillates laser light has a resonator in which a laser medium, generating radiation light by supplied pumping energy, is disposed on the resonance optical path, Q switch means for modulating resonator loss of the resonator, and pumping means for continuously supplying pumping energy to the laser medium.

In such a laser light source, the inverted population of the laser medium is increased by the pumping means supplying the pumping energy, when the Q switch means sets the resonator loss of the resonator to a large value, and when the Q switch means sets the resonator loss of the resonator to a small value thereafter, an induced emission is quickly generated in the laser medium disposed on the resonance optical path of the resonator. The induced radiation light is outputted from the resonator to the outside as laser light. By performing the modulation periodically, pulsed laser light having high peak power are output. Such a laser light source, which can output pulsed light having high peak power, is used in many fields that include laser processing, optical measurement and optical communication.

Japanese Patent No. 3331726 discloses a method for using an acousto-optical (AO) element for the Q switch means.

### SUMMARY OF THE INVENTION

The present inventors have examined the conventional laser light source, and as a result, have discovered the following problems.

That is, recently demands for a laser light source that can output pulsed laser light having high peak power are increased due to the expanded application uses. Therefore, a laser light source that has high durability supporting a much higher power output is demanded compared with the case of using an acousto-optical element for Q switch means, as the case of an optical fiber laser device according to Japanese Patent No. 3331726 (Document 1).

The present invention has been developed to eliminate the problems described above. It is an object of the present invention to provide a laser light source having a structure to implement high durability supporting high power output.

In order to achieve the above object, a laser light source according to the present invention is a laser light source that pulse-oscillates laser light, and has, as a first configuration, a resonator, a rare earth element doped fiber, pumping means, Q switch means and a condensing lens. The resonator forms a resonation optical path. The rare earth element doped fiber is inserted on the resonance optical path and outputs radiation light by supply of pumping energy. The pumping means continuously supplies pumping energy to the rare earth element doped fiber. The Q switch means modulates resonator loss of the resonator. The condensing lens is disposed on the resonance optical path between an end face of the rare earth element doped fiber and the Q switch means, and condenses the radiation light whose spot size has been expanded (radiation light of which beam diameter has been enlarged) and which propagates from the rare earth element doped fiber to the Q switch means. In order to expand the radiation light that enters the condensing lens, a lens is disposed on the resonance optical path between the end face of the rare earth element doped fiber and the condensing lens, and the radiation light, propagating from the rare earth element doped fiber to the Q switch means, is collimated by the lens in a state of being expanded to be a predetermined beam diameter. The Q switch means is disposed such that a portion contributing to at least a resonator loss modulation is located in the condensing point of the condensing lens, and mechanically changes formation and interruption of the resonance optical path.

In the laser light source having the above first configuration, the radiation light outputted from the fiber, to which pumping energy is continuously supplied, is condensed by the condensing lens and enters the Q switch means. Here. In the case that the radiation light is transmitted by the Q switch means at this time, the resonation optical path of the radiation light is formed between the reflection face and the emission face. In the case that the radiation light is interrupted by the Q switch means, on the other hand, the resonance optical path is not formed, so the resonator loss becomes the maximum. In this way, in accordance with the laser light source, formation and interruption of the resonance optical path are implemented by periodically changing transmission and interruption of the radiation light by the Q switch means, and pulsed light is emitted. The Q switch means constituting the laser light source has a higher durability supporting radiation light, which is output at high power, than the Q switch means based on an acousto-optical element, and can suppress damage of the laser light source. Hence the laser light source having high durability supporting high power output can be provided. By disposing the Q switch means in the condensing point of the condensing lens, it becomes easier to increase the cyclic frequency related to switching of the Q switch means, and high frequency pulsed light can be emitted. This configuration can be created with less cost than the Q switch means based on an acousto-optical element.

As a configuration to effectively implement the above function, the Q switch means includes a disk, disposed such that a part thereof is located on the resonance optical path, and a driving section. The disk has a plate portion absorbing or scattering the radiation light, and a plurality of openings arranged on a circumference centered around a rotation axis penetrating the center of the disk. The driving section rotates the disk centered around the rotation axis.

As another configuration for effectively implementing the above function, the Q switch means may includes a masking portion and a driving section. The masking portion absorbs or scatters the radiation light. The driving section moves the position of the masking portion periodically by vibrating the masking portion along a direction crossing the optical axis of the resonance optical path at a predetermined angle (including a right angle).

The laser light source according to the present invention, as a second configuration, may have a resonator forming a resonation optical path between a reflection face and an emission face, a rare earth element doped fiber, pumping means, and Q switch means. In this configuration, the rare earth element doped fiber is inserted on the resonance optical path, and outputs radiation light by supply of pumping energy. The pumping means continuously supplies pumping energy to the rare earth element doped fiber. The Q switch means modulates resonator loss of the resonator. The Q switch means, in particular, mechanically changes formation and interruption of the resonance optical path by adjusting the position of the reflection face.

In accordance with the laser light source having the second configuration, the formation and interruption of the resonance optical path is mechanically changed by the periodic positional change of the reflection face constituting the resonator. This allows functioning as a Q switch means for modulating the resonator loss, and a laser light source having higher durability than the Q switch means based on an acousto-optical element, even during high power output, can be provided.

As a configuration to effectively implement the above function, the Q switch means includes a polygonal prism-shaped rotation body and a driving section. The rotation body has a central axis matching the axis perpendicular to the optical axis of the resonance optical path, and has a polygonal profile of the cross-section perpendicular to the central axis. The rotation body has a reflection mirror constituting a part of the resonator on each side face which includes the side of the polygonal cross-section, and is disposed such that each of the reflection mirror sequentially functions as the reflection portion in the resonator when the rotation body rotates around the central axis as the rotation axis. The driving section rotates the rotation body around the central axis as the rotation axis. By this configuration, the rotation body changes formation and interruption of the resonance optical path by rotating around the central axis as the rotation axis.

As another configuration to effectively implement the above function, the Q switch means includes a disk that includes a plate portion and a reflection portion constituting a part of the resonator, and a driving section. The disk is disposed such that a part thereof is located on the resonance optical path. The plate portion transmits, absorbs or scatters the radiation light. The reflection portion is disposed on a circumference centered around a rotation axis penetrating the center of the disk, and reflects the radiation light so as to constitute a part of the resonator. The driving section rotates the disk centered around the rotation axis. By this configuration, the disk mechanically changes, by rotation thereof, formation and interruption of the resonance optical path.

As another configuration to effectively implement the above function, the Q switch means includes a reflection plate that constitutes a part of the resonator and reflects the radiation light, and a driving section. The driving section periodically moves the position of the reflection plate by vibrating the reflection plate along the direction perpendicular to the optical axis of the resonance optical path. By this configuration, the reflection plate mechanically changes, by changing the position thereof, formation and interruption of the resonance optical path.

### BRIEF DESCRIPTION OF THE DRAWINGS

FIG. 1 is a diagram showing a configuration of a first embodiment of a laser light source according to the present invention;

FIGS. 2A to 2C are diagrams showing a structure of a chopper disk and other arrangement examples;

FIGS. 3A and 3B are diagrams showing a configuration of a second embodiment of a laser light source according to the present invention;

FIG. 4 is a diagram showing a configuration of a third embodiment of a laser light source according to the present invention;

FIG. 5 is a diagram showing a configuration of a fourth embodiment of a laser light source according to the present invention;

FIG. 6 is a diagram showing a structure of a disk; and

FIG. 7 is a diagram showing a configuration of a fifth embodiment of a laser light source according to the present invention.

### DESCRIPTION OF THE PREFERRED EMBODIMENTS

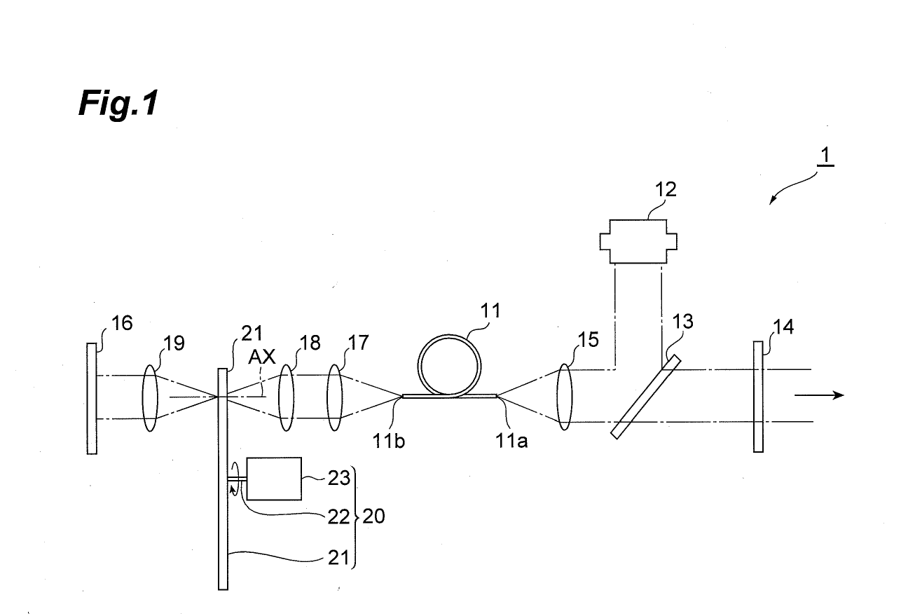

In the following, embodiments of a laser light source according to the present invention will be described in detail with reference to FIGS. 1, 2A to 3B and 4 to 7. In the description of the drawings, identical or corresponding components are designated by the same reference numerals, and overlapping description is omitted.

### First Embodiment

A first embodiment of the laser light source according to the present invention will now be described. FIG. 1 is a diagram showing a configuration of a laser light source 1 according to a first embodiment. The laser light source 1, shown in FIG. 1, has an optical amplification fiber 11, pumping light source 12, dichroic mirror 13, output mirror (low reflection mirror) 14, condensing lens 15, total reflection mirror 16, lenses 17, 18 and 19 and Q switch means 20.

The optical amplification fiber 11 is an amplification medium constituted by an optical fiber whose optical waveguide region is doped with a rare earth element having fluorescent characteristics. When pumping light, having a wavelength that can pump the fluorescent element, is supplied to the optical amplification fiber 11, the rare earth element emits fluorescent light. The rare earth element is preferably a Yb element, Nd element, Pr element or Er element.

The pumping light source 12 continuously outputs pumping light for pumping the fluorescent element doped to the optical amplification fiber 11. This pumping light source 12 preferably includes a laser diode. The dichroic mirror 13 emits the pumping light, which is outputted from the pumping light source 12, to the lens 15. The dichroic mirror 13 also outputs the light, which is reflected by the output mirror 14, to the lens 15. The dichroic mirror 13 also outputs the radiation light, which is emitted from the fluorescent element of the optical amplification fiber 11, outputted from the end face 11a, enters the lens 15, and emitted from the lens 15, to the output mirror 14.

The lens 15 is disposed such that the focal point thereof matches the end face 11a of the optical amplification fiber 11, and condenses the light outputted from the dichroic mirror 13 to the end face 11a of the optical amplification fiber 11. The lens 15 also collimates the radiation light outputted from the end face 11a of the optical amplification fiber 11. The radiation light collimated by the lens 15 reaches the dichroic mirror 13.

The lens 17 is disposed such that the focal point thereof matches the end face 11b of the optical amplification fiber 11, and collimates the radiation light outputted from the end face 11b of the optical amplification fiber 11. The lens 17 also condenses the radiation light outputted from the lens 18 to the end face 11b of the optical amplification fiber 11.

The lens 18 functions as a condensing lens that condenses the radiation light having being outputted from the end face 11a of the optical amplification fiber 11 and then collimated by the lens 17. The radiation light collimated by the lens 17 is condensed to the condensing point of the lens 18, and is inputted to the Q switch means 20 disposed in the condensing point. The lens 18, on the other hand, collimates the radiation light outputted from the Q switch means 20, and this collimated radiation light reaches the lens 17. For the lens 18, a condensing lens (achromatic lens) of which chromatic aberration is corrected, for example, is used.

The lens 19 collimates the radiation light outputted from the Q switch means 20, and outputs it to the totals reflection mirror 16, and also condenses the radiation light from the total reflection mirror 16. The lens 18 and the lens 19 are disposed so that the focal point at the side of the Q switch means 20 of the lens 18 and the focal point at the side of the Q switch means 20 of the lens 19 match. And the Q switch means 20, particularly the portion that contributes to the modulation of the resonance optical path loss, is disposed in this focal point.

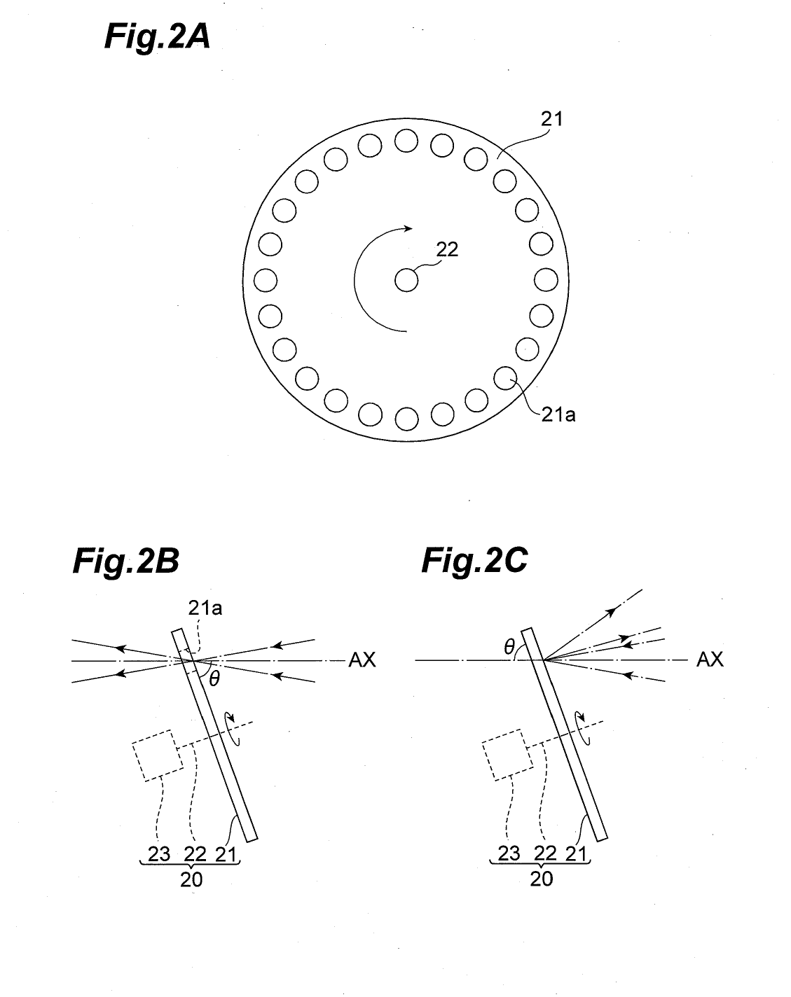

The Q switch means 20 has a chopper disk (disk) 21, a rotation axis 22 and a driving section 23. The chopper disk 21 has a plate portion of which surface scatters or absorbs light, and a plurality of openings 21a disposed on a circumference centered around the rotation axis 22, as shown in FIG. 2A. The openings 21a are disposed on the circumference centered around the rotation axis 22 of the chopper disk 21 with equal spacing. The chopper disk 21 and the rotation axis 22 thereof are disposed so that the openings 21a pass the condensing position of the radiation light by the lens 18 when the chopper disk 21 is rotated around the rotation axis 22. The driving section 23 is disposed for rotating this rotation axis 22. The driving section 23 includes a motor. By the driving section 23 rotating the rotation axis 22 and the chopper disk 21 at a predetermined speed, the plate portion and the openings 21a of the chopper disk 21 alternately pass through the condensing point of the radiation light, which is condensed by the lens 18.

In the configuration shown in FIG. 1, the chopper disk 21 is disposed so as to be perpendicular to the optical axis AX of the resonance optical path, but may be disposed in a state inclined from the optical axis AX by the angle θ, as shown in FIGS. 2B and 2C. In this case, the plate portion of the chopper disk 21 may be constituted by a material that reflects light from the optical amplification fiber 11. In this example, when the opening 21a is located in the condensing point of the lens 18 which is a condensing lens, as shown in FIG. 2B the light condensed by the lens 18 transmits through the opening 21a to the lens 19, and the resonance optical path is formed. When the plate portion of the chopper disk 21 is located in the condensing point of the lens 18, on the other hand, the light condensed by the lens 18 is reflected and cannot reach the lens 19, as shown in FIG. 2C (resonance optical path interrupted state).

In the laser light source 1 having the above configuration, the pumping light, which is continuously outputted from the pumping light source 12, is outputted to the lens 15 by the dichroic mirror 13. The pumping light condensed by the lens 15 is inputted to the optical amplification fiber 11, which is a laser medium, through the end face 11a, and pumps the fluorescent element doped to the optical amplification fiber 11. In other words, the output mirror 14 and the total reflection mirror 16 constitutes a Fabry-Perot resonator, and the optical amplification fiber 11 as a laser medium is disposed on the resonance optical path of the resonator.

The radiation light emitted from the end face 11b of the optical amplification fiber is collimated by the lens 17 and is condensed by the lens 18. When the opening 21a of the chopper disk 21 constituting the Q switch means 20 is located in the focal point of the lens 18 (lens 19) at this time, the radiation light that is outputted from the lens 18 transmits through the opening 21a of the chopper disk 21, and reaches the lens 19. Then the radiation light collimated by the lens 19 reaches the total reflection mirror 16. The radiation light reflected by the total reflection mirror 16 is condensed again by the lens 19. And when the opening 21a of the chopper disk 21 is located in the focal point of the lens 18 (lens 19), the light which is inputted to the lens 18 through the opening 21a, collimated by the lens 18, and then condensed by the lens 17, enters the end face 11b of the optical amplification fiber 11. The radiation light, which is outputted from the end face 11a of the optical amplification fiber 11, transmits through the dichroic mirror 13, and reaches the output mirror 14. Out of the radiation light that reached the output mirror 14, a part transmits through the output mirror 14, and the rest is reflected by the output mirror 14, and enters the lens 15 again via the dichroic mirror 13.

As described above, when the opening 21a of the chopper disk 21 is located in the condensing position of the lens 18 (condensing position of lens 19), the radiation light can transmit through this opening 21a. When the plate portion of the chopper disk 21 is located in the condensing point of the lens 18, the radiation light, having been outputted from the lens 18 and reached the chopper disk 21, is absorbed or scattered by the surface of the chopper disk 21. This makes the resonator loss of the resonator the maximum. As described above, the chopper disk 21 according to the present embodiment can function as the Q switch means 20 by rotating and switching the transmission and interruption of the radiation light, and output the pulsed light from the resonator.

A concrete configuration example of the laser light source 1 according to the first embodiment is as follows. The optical amplification fiber 11 is an optical fiber whose optical waveguide region is doped with a Yb element. The pumping light source 12 outputs pumping light with a wavelength of 975 nm that can pump the Yb element. In the case that the pumping light with the wavelength of 975 nm is supplied, the optical amplification fiber 11 emits a fluorescence with a wavelength of 1.06 μm. The dichroic mirror 13 disposed in the position where the pumping light, outputted from the pumping light source 12, reaches reflect light with the wavelength of 975 nm, and transmits light with the wavelength of 1.06 μm. The lenses 15, 18 and 19 are lenses with focal distance f=50 mm, and the lens 17 is an achromatic lens with focal distance f=50 mm. The chopper disk 21 constituting the Q switch means 20 is an SUS of which diameter is 40 mm and thickness is 0.3 mm, and the surface thereof is processed so that the light is absorbed or scattered as the plate portion. The diameter of the opening 21a formed in the chopper disk is 1 mm. The rotation speed of the driving section 23 that rotates the chopper disk 21 is 8000 rpm.

In accordance with the laser light source 1 according to the first embodiment, the Q switch means 20 constituted by the chopper disk 21 having the openings 21a mechanically opens transmission and interruption of the radiation light to change the formation and interruption of the resonance optical path, as mentioned above. Thereby the resistance to irradiation intensity becomes stronger than the case of using an acousto-optical element as the Q switch means, and as a result, high durability supporting high power output can be implemented.

In this laser light source 1, the lenses 17 and 18 are disposed between the Q switch means 20 and the end face 11b of the optical amplification fiber 11. Therefore, volatile constituents generated by thermal damage (e.g. aberration) of the chopper disk 21, by irradiation of the radiation light to the chopper disk 21 by the Q switch means 20, does not adhere to the end face 11b of the optical amplification fiber 11, and a drop in performance of the laser light source 1, due to contamination of the end face 11b, can be suppressed.

In the laser light source 1, the Q switch means 20 is disposed at the condensing point of the lenses 18 and 19, and the radiation light condensed by the lenses 18 and 19 enters the Q switch means 20. Since the Q switch means 20 is used for the condensed radiation light like this, the formation and interruption of the resonance optical path can be switched at high-speed by the chopper disk 21 constituting the Q switch means 20 rotating at high-speed. Furthermore, the time width of the laser pulsed light that is outputted from the laser light source 1 can be decreased.

### Second Embodiment

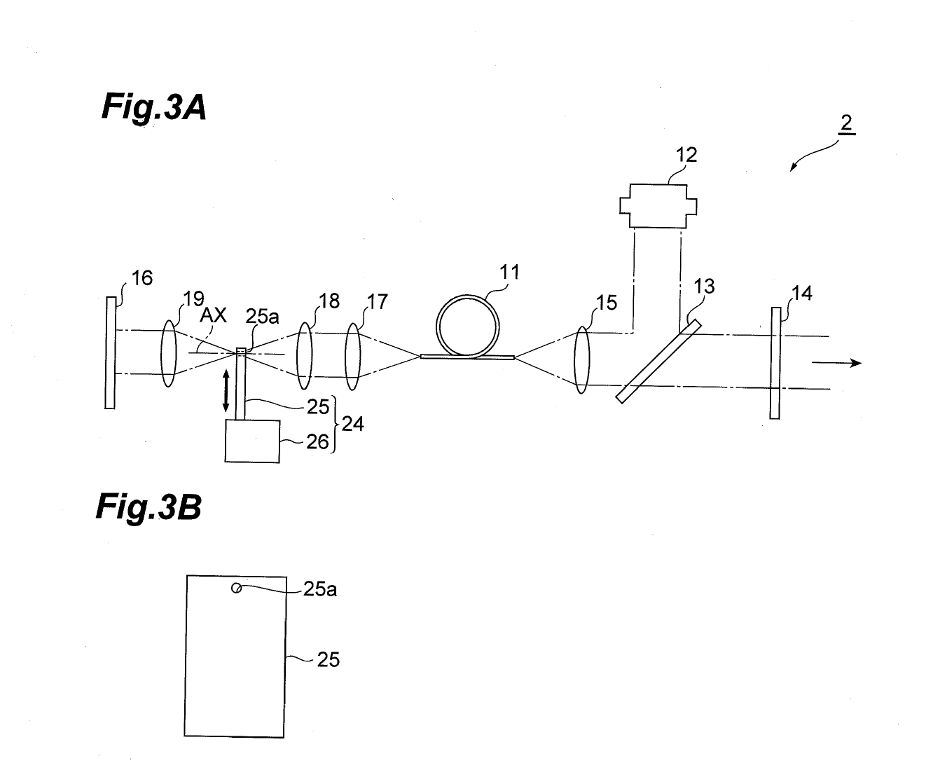

A second embodiment of the laser light source according to the present invention will now be described. FIG. 3A is a diagram showing a configuration of a laser light source 2 according to the second embodiment. The laser light source 2 according to the second embodiment is the same as the laser light source 1 according to the first embodiment (FIG. 1), except that the Q switch means 24 is comprised of a plate type shielding plate 25 and a driving section 26 that moves this shielding plate 25 by vibration.

In other words, in the laser light source 2 according to the second embodiment, when the shielding plate 25 constituting the Q switch means 24 is located in the condensing point of the lenses 18 and 19, the light is absorbed or scattered by the shielding plate 25, so the radiation light, which is outputted from the end face 11b of the optical amplification fiber 11, is interrupted. Therefore, the resonance optical path of the resonator is interrupted, and resonator loss becomes the maximum. When the shielding plate 25 is not located in the condensing point of the lenses 18 and 19, namely, when the edge of the shielding portion 25 or the opening 25a or slit created in the shielding portion 25 is located in the condensing point of the lenses 18 and 19, the radiation light outputted from the lens 18 is inputted to the lens 19, and the radiation light outputted from the lens 19 is inputted to the lens 18. As FIG. 3B shows, an opening 25a where the radiation light can transmit is created in the shielding portion 25. Therefore, a resonance optical path is formed when the radiation light transmits through the opening 25a of the shielding portion 25. And, the position of the shielding portion 25 is changed by the driving section 26 vibrating the shielding plate 25 along a direction perpendicular to the optical axis AX of the resonance optical path. By implementing this positional change of the shielding portion 25, the formation and interruption of the resonance optical path can be switched. The vibrating shielding portion itself can function as the Q switch means 20, and output the pulsed light from the laser light source 2.

A concrete configuration example of the laser light source 2 according to the second embodiment (FIG. 3) is the same as the laser light source 1 according to the first embodiment, except for the Q switch means 24. The shielding plate 25 constituting the Q switch means 24 is an SUS of which size is 10 mm×20 mm, with a 0.3 mm thickness, and is processed so as to absorb or scatter the light irradiated on the surface thereof. The driving section 26 is constituted by a piezoelectric element.

In the configuration example of FIG. 3, the shielding portion 25, on which the above mentioned surface processing is performed, is disposed such that the surface thereof is perpendicular to the optical axis AX of the resonance optical path, but the present invention is not limited to this arrangement. In particular, when the above mentioned surface processing is not performed on the shielding portion 25, it is preferable to dispose the shielding portion 25 so as to incline from the optical path AX of the resonance optical path by a predetermined angle θ, as shown in FIGS. 2B and 2C. In this case, the shielding portion 25 vibrates in a direction inclined from the optical axis AX by angle θ, so the transmission and reflection of the radiation light, that is directed from the end face of the optical amplification fiber 11 to the total reflection mirror 16, can be implemented. In other words, the resonance optical path is formed when the radiation light transmits through the opening 25a of the shielding portion 25, and the resonance optical path is interrupted when the radiation light from the optical amplification fiber 11 is absorbed or reflected by the shielding portion 25.

In the case of the laser light source 2 according to the second embodiment as well, just like the laser light source 1 according to the first embodiment, the Q switch means 24, for switching formation and interruption of the resonance optical path, has higher resistance to irradiation intensity than the case of using the acousto-optical element as the Q switch means, so high durability supporting high power output can be implemented.

Also just like the laser light source 1 according to the first embodiment, volatile constituents, generated by thermal damage of the shielding plate 25 by irradiation of the radiation light to the shielding plate 25 constituting the Q switch means 24, do not adhere to the end face 11b of the optical amplification fiber 11, and a drop in performance of the laser light source 2 due to contamination of the end face 11b can be suppressed.

Furthermore, just like the laser light source 1 according to the first embodiment, the Q switch means 24 is disposed in the condensing point of the lenses 18 and 19, and the radiation light condensed by the lenses 18 and 19 enters the Q switch means 24. Therefore, formation and interruption of the resonance optical path can be switched at high-speed by moving the position of the shielding plate 25 constituting the Q switch means 24 at high-speed, and the time width of the laser pulsed light that is outputted from the laser light source 2 can be decreased.

### Third Embodiment

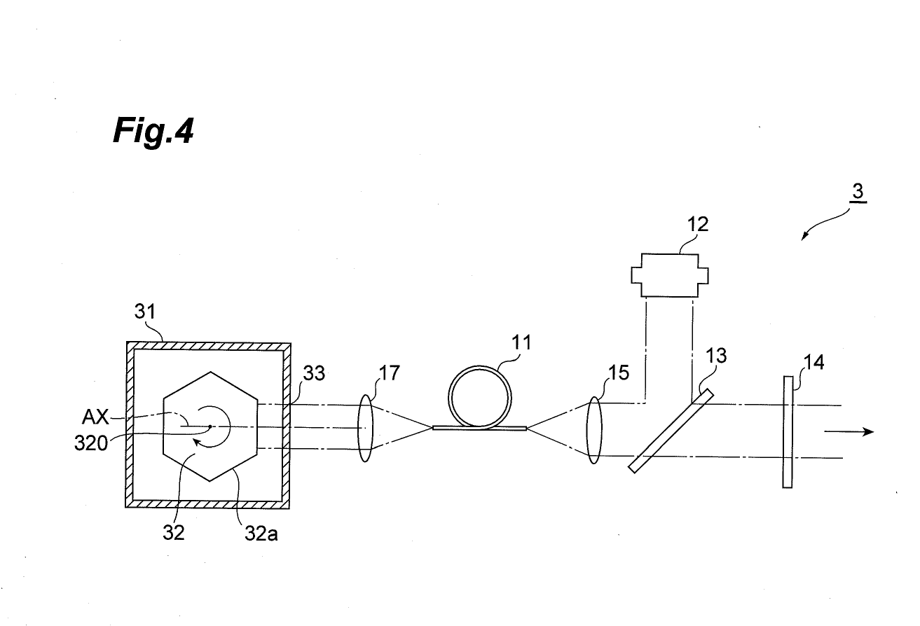

A third embodiment of the laser light source according to the present invention will now be described. FIG. 4 is a diagram showing a configuration of a laser light source 3 according to the third embodiment. The laser light source 3 according to the third embodiment The laser light source 4 according to the fourth embodiment is different from the laser light source 1 according to the first embodiment (FIG. 1) in the point that the reflection plane constituting the resonator is constituted by a plurality of mirrors, and these mirrors are sequentially moved so as to function as the Q switch means.

In other words, instead of the total reflection mirror 16 of the laser light source 1 according to the first embodiment, the laser light source 3 according to the third embodiment has a rotary drive mirror 32. Specifically, for the radiation light which is outputted from the end face 11b of the optical amplification fiber 11, the rotary drive mirror 32 is in concrete terms a polygonal prism (hexagonal prism of which profile of the cross-section perpendicular to the rotation axis 320 is a hexagon, in the case of FIG. 4), that can rotate around the rotation axis 320 that is perpendicular to the optical axis of light collimated by the lens 17 (matching the optical axis AX of the resonance optical path), and the side face 32a thereof is covered with a reflection mirror. By the driving section, which is not illustrated, rotating the rotary drive mirror 32 around the rotation axis, the reflection mirror of the side face 32a moves. The rotary drive mirror 32 is in a black box 31, and a pin hole 33 with a 3 mm diameter, for example, is created only on the surface where the radiation light collimated by the lens 17 enters.

In the laser light source 3 having this configuration, the radiation light, that is emitted from the end face 11b of the optical amplification fiber 11 and is collimated by the lens 17, enters into the black box 31 via the pin hole 33, and irradiates the side face 32a of the rotary drive mirror 32 disposed inside the black box 31.

When one of the side faces 32a of the rotary drive mirror 32 is perpendicular to the entry direction of the radiation light, at this time, the radiation light that reached the side face 32a is reflected by the side face 32a. Then the radiation light reflected by the side face 32a is emitted from the pin hole 33 again, and enters the lens 17, whereby the resonance optical path is formed. When the side face 32a is not perpendicular to the entry direction of the radiation light, on the other hand, the radiation light that reached the side face 32a is reflected in a direction different from the entry direction by the side face 32a. At this time, the reflected radiation light is not emitted to the outside from the black box 31 (resonance optical path is interrupted), and resonator loss becomes the maximum. By the driving section rotating the rotary drive mirror 32, the rotary drive mirror 32 functions as the Q switch means, and the state of forming and the state of interrupting the resonance optical path are alternately repeated by the side face 32a. As a result, the pulsed light can be outputted from the laser light source 3.

In the case of the laser light source 3 according to the third embodiment, the reflection plane constituting the resonance optical path functions as the Q switch means for switching formation and interruption of the resonance optical path, so higher durability supporting high power output can be implemented compared with the case of using an acousto-optical element as the Q switch means.

The side faces 32a of the rotary drive mirror 32 that function as the Q switch means are covered with the total reflection mirror, and thermal damage of the mirror due to irradiation of the radiation light is not generated, therefore generation of damage on the end face 11b of the optical amplification fiber 11 is suppressed. Furthermore, the lens 17 is disposed between the black box 31, in which the rotary drive mirror 32 is disposed, and the end face 11b of the optical amplification fiber 11, therefore even when the black box 31 is damaged by heat of the radiation light reflected by the rotary drive mirror 32, a drop in performance, caused by contaminants adhering to the end face 11b of the optical amplification fiber 11 due to this thermal damage, can be suppressed.

### Fourth Embodiment

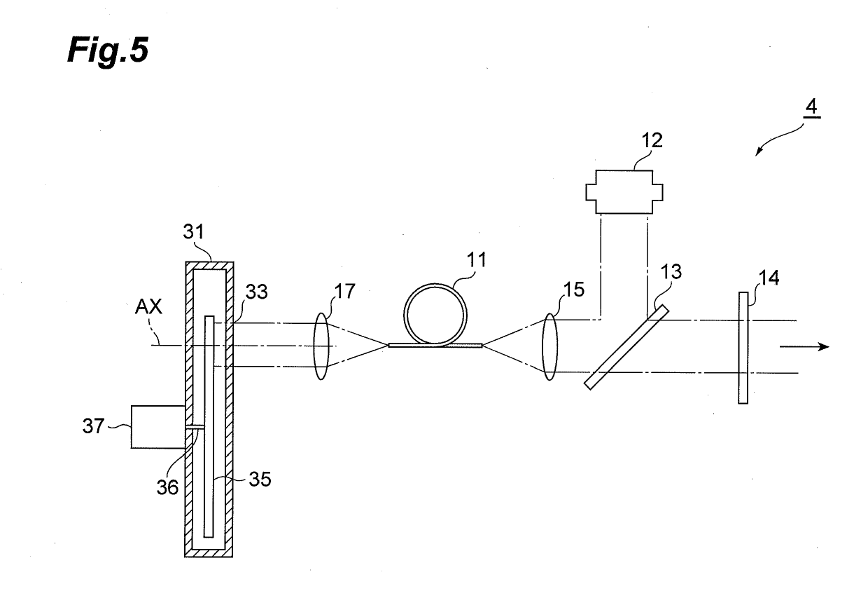

A fourth embodiment of a laser light source according to the present invention will now be described. FIG. 5 is a diagram showing a configuration of the laser light source 4 according to the fourth embodiment. The laser light source 4 according to the fourth embodiment is the difference from the laser light source 3 according to the third embodiment (FIG. 4) in the point that a reflection face constituting the resonator is disposed on the surface of a disk that rotates around the rotation axis, and moves so as to function as the Q switch means.

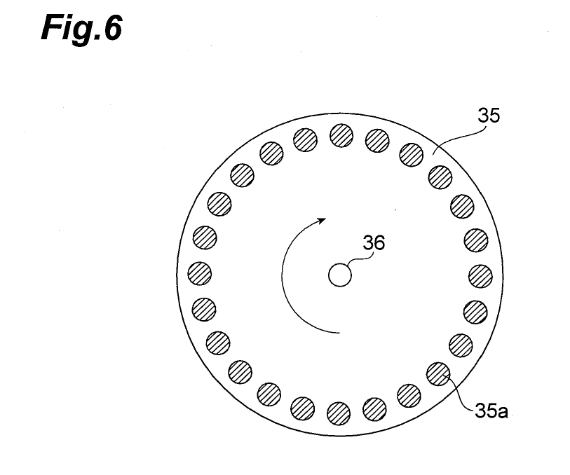

In the laser light source 4 according to the fourth embodiment, a disk 35 that is rotated around the rotation axis 36 by the driving section 37 is disposed inside the black box 31, instead of the rotary drive mirror 32 of the laser light source 3 according to the third embodiment. The disk 35 is an alumite-treated aluminum plate with a diameter of 40 mm, for example, and has the rotation axis 36 at the center thereof. The disk 35 also has a plurality of reflection portions 35a on the circumference centered around the rotation axis 36, as shown in FIG. 6. The reflection portions 35a, which are circular total reflection mirrors with a 3.5 mm diameter, for example, are disposed on the circumference centered around the rotation axis 36 at an equal interval. The surface of the reflection portion 35a forms a surface perpendicular to the radiation light which was emitted from the lens 17, and enters the black box 31 via the pin hole 33. The disk 35 and the rotation axis 36 thereof are disposed such that the reflection portion 35a is located in the irradiation position of the radiation light, which is outputted from the lens 17 and enters via the pin hole 33, when the disk 35 is rotated around the rotation axis 36. The driving section 37 is disposed to rotate the rotation axis 36. The driving section 37 is constituted by a motor or the like, and rotates the rotation axis 36 and the disk 35 at a predetermined speed, so that the plate portion (portion that is not the reflection portion 35a) and the reflection portion 35a of the disk 35 alternately passes the irradiation position of the radiation light. In FIG. 5, the driving section 37 is disposed outside the black box 31, but may be disposed inside the black box 31.

In this laser light source 4, when the reflection portion 35a of the disk 35 is located in the irradiation position of the radiation light which enters the black box 31 via the pin hole 33, the radiation light is reflected by the reflection portion 35a, and enters the lens 17 again via the pin hole 33. Thereby, the resonance optical path is formed. When the plate portion of the disk 35 is located in the irradiation position of the radiation light, on the other hand, the radiation light that enters the black box 31 via the pin hole 33 is absorbed or scattered by the surface of the disk 35, and is not emitted from the pin hole 33 of the black box 31. Hence, the resonance optical path is interrupted and the resonator loss of the resonator becomes the maximum. In the case of the laser light source 4 according to the fourth embodiment, the disk 35 functions as the Q switch means by rotating and locating the reflection portion 35a and the plate portion alternately in the irradiation portion of the radiation light so as to switch formation and interruption of the radiation optical path, and as a result, pulsed light can be outputted from the resonator.

In the laser light source 4 having the above configuration, the reflection plane constituting the resonance optical path is a disk 35, and functions as the Q switch means for switching the formation and interruption of the resonance optical path by rotating, so high durability supporting high power output can be implemented compared with the case of using an acousto-optical element as the Q switch means.

The disk 35, functioning as the Q switch means, is covered by the black box 31, and the lens 17 is disposed between the black box 31 and the end face 11b of the optical amplification fiber 11, therefore even when the disk 35 and black box 31 are damaged by heat of the radiation light, a drop in performance, caused by contaminants adhering to the end face 11b of the optical amplification fiber 11 due to this thermal damage, can be suppressed.

### Fifth Embodiment

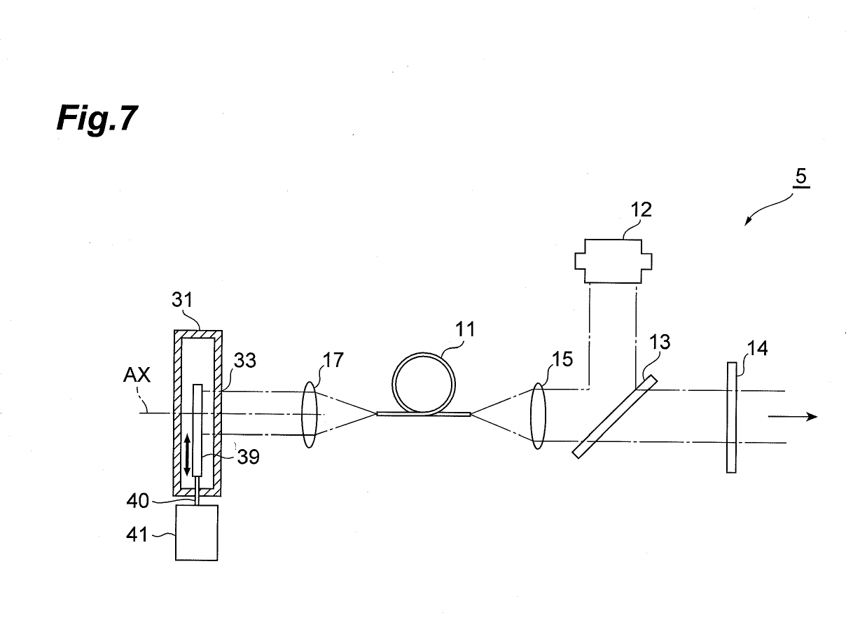

A fifth embodiment of a laser light source according to the present invention will now be described. FIG. 7 is a diagram showing a configuration of the laser light source 5 according to the fifth embodiment. The laser light source 5 according to the fifth embodiment is the same as the laser light source 4 according to the fourth embodiment (FIG. 5), except that a total reflection mirror 39 of which reflection face constituting the resonator is a plate, and a driving section 41 moves this total reflection mirror 39 by vibration so as to constitute the Q switch means.

In the laser light source 5 according to the fifth embodiment, the total reflection mirror 39, which is moved by the driving section 41 via the support portion 40, is disposed in the black box 31, instead of the disk 35 of the laser light source 4 according to the fourth embodiment. The driving section 41 is constituted by a piezoelectric element, for example. The total reflection mirror 39 is disposed to be perpendicular to the optical path of the radiation light when the total reflection mirror 39 is located in the irradiation position of the radiation light that entered the black box 31 via the pin hole 33. And, when the total reflection mirror 39 is located in the irradiation position of the radiation light, the radiation light is reflected by the total reflection mirror 39, and enters the lens 17 again via the pin hole 33. Thereby the resonance optical path is formed. On the other hand, when the total reflection mirror 39 is not located in the irradiation position of the radiation light, that is, when the edge of the total reflection mirror 39 or an opening or slit created in the total reflection mirror 39 is located in the irradiation position of the radiation light, the radiation light which entered the black box 31 via the pin hole 33 reaches the inner wall of the black box 31. Therefore, the resonance optical path is interrupted and the resonator loss of the resonator becomes the maximum. The shape of the total reflection mirror 39 is the same as the shape of the shielding portion 25, shown in FIG. 3B. The driving section 40 repeats formation and interruption of the resonance optical path by moving the total reflection mirror 39. As a result, the black box 31 enclosing the total reflection mirror 39 functions as the Q switch means, and can output the pulsed light from the resonator.

Therefore, in the case of the laser light source 5 according to the fifth embodiment as well, the reflection face constituting the resonance optical path is the total reflection mirror 39 that is moved by the driving section 41, and functions as a Q switch means that switches formation and interruption of the resonance optical path by movement of the total reflection mirror 39, therefore higher durability supporting high power output can be implemented than with the case of using the acousto-optical element as the Q switch means.

The disk 35 that functions as the Q switch means is covered by the black box 31, and the lens 17 is disposed between the black box 31 and the end face 11b of the optical amplification fiber 11, therefore even when the disk 35 and black box 31 are damaged by heat of the radiation light, a drop in performance, caused by contaminants adhering to the end face 11b of the optical amplification fiber 11 due to this thermal damage, can be suppressed.

As a variant form of the laser light source 5 according to the fifth embodiment, the total reflection mirror 39 can function as the Q switch means by changing the angle of the total reflection mirror 39 with respect to the radiation light using the driving section 41, instead of the position of the total reflection mirror 39. In concrete terms, when the total reflection mirror 39 is a plane perpendicular to the radiation light that enters the black box 31 via the pin hole 33, the radiation light is reflected to the pin hole 33, so the resonance optical path is formed.

When the total reflection mirror 39 is not a plane perpendicular to the radiation light, on the other hand, the radiation light is reflected by the total reflection mirror 39 in a direction different from the direction to the pin hole 33, so the resonance optical path is interrupted, and resonator loss becomes the maximum. In the case of changing the angle of the total reflection mirror 39 like this as well, the pulsed light can be outputted from the laser light source 5. According to this variant form as well, high durability supporting high power output can be implemented.

Embodiments of the present invention were described above, but the present invention is not limited to these embodiments, but can be modified in various ways.

For example, according to the first embodiment and the second embodiment, the Q switch means 20 or 24 is disposed between the end face 11b of the optical amplification fiber 11 and the total reflection mirror 16, but may be disposed in another location in the resonator, such as a location between the lens 15 and dichroic mirror 13.

As described above, in accordance with the present invention, a laser light source having high durability supporting high power output can be implemented.

What is claimed is:

1. A laser light source pulse-oscillating laser light, comprising:
a resonator forming a resonation optical path;
a rare earth element doped fiber inserted on the resonance optical path, the rare earth element doped fiber outputting radiation light by supply of pumping energy;
pumping means for continuously supplying pumping energy to the rare earth element doped fiber;
Q switch means for modulating resonator loss of the resonator; and
a condensing lens provided on the resonance optical path between an end face of the rare earth element doped fiber and the Q switch means, the condensing lens condensing the radiation light whose spot size has been expanded and which propagates from the rare earth element doped fiber to the Q switch means,
wherein the Q switch means is disposed such that a portion that contributes to at least a resonator loss modulation is located at the condensing point of the condensing lens and mechanically change formation and interruption of the resource optical path.

2. A laser light source according to claim 1, further comprising a lens disposed on the resonance optical path between the end face of the rare earth element doped fiber and the condensing lens, the lens collimating the radiation light which propagates from the rare earth element doped fiber to the condensing lens.

3. A laser light source according to claim 1, wherein the Q switch means includes:
a disk disposed such that a part thereof is located on the resonance optical path, the disk having a plate portion absorbing or scattering the radiation light, and a plurality of openings arrayed on a circumference centered around a rotation axis penetrating the center of the disk; and
a driving section rotating the disk centered around the rotation axis.

4. A laser light source according to claim 1, wherein the Q switch means includes:
a masking portion absorbing or scattering the radiation light; and
a driving section moving the position of the masking portion periodically by vibrating the masking portion along a direction crossing the optical axis of the resonance optical path at a predetermined angle.

5. A laser light source for pulse-oscillating laser light, comprising:
a resonator forming a resonation optical path between a reflection face and an emission face;
a rare earth element doped fiber inserted on the resonance optical path, the rare earth element doped fiber outputting radiation light by supply of pumping energy;
pumping means for continuously supplying pumping energy to the rare earth element doped fiber; and
Q switch means for modulating resonator loss of the resonator,
wherein the Q switch means has a structure for adjusting the position of the reflection face, and mechanically changes formation and interruption of the resonance optical path by adjusting the position of the reflection face.

6. A laser light source according to claim 5, wherein the Q switch means includes:
a polygonal prism-shaped rotation body which has a central axis matching the axis perpendicular to the optical axis of the resonance optical path, and has a polygonal profile of a cross-section perpendicular to the central axis, the rotation body having a reflection mirror constituting a port of the resonator on each side face thereof which includes a side of the polygonal cross-section, and being disposed such that each of the reflection mirrors sequentially functions as the reflection portion in the resonator when the rotation body rotates around the central axis as the rotation axis; and
a driving section rotating the rotation body around the central axis as the rotation axis,
whereby the rotation body mechanically changes formation and interruption of the resonance optical path by rotating around the central axis as the rotation axis.

7. A laser light source according to claim 5, wherein the Q switch means includes:
a disk disposed such that a part thereof is located on the resonance optical path, the disk including a plate portion which transmits, absorbs or scatters the radiation light, and a reflection portion which is disposed on a circumference centered around a rotation axis penetrating the center of the disk and reflects the radiation light so as to constitute a part of the resonator; and a driving section rotating the disk centered around the rotation axis,
whereby the disk, by rotation thereof, mechanically changes formation and interruption of the resonance optical path.

8. A laser light source according to claim 5, wherein the Q switch means includes:
a reflection plate constituting a part of the resonator and reflecting the radiation light; and
a driving section periodically moving the position of the reflection plate by vibrating the reflection plate along a direction perpendicular to the optical axis of the resonance optical path,
whereby the reflection plate mechanically changes, by changing the position thereof, formation and interruption of the resonation optical path.
